(19) United States
(12) Patent Application Publication
(10) Pub. No.: US 2012/0136714 A1
(43) Pub. Date: May 31, 2012

(54) USER INTENT ANALYSIS ENGINE

(76) Inventors: Diaz NESAMONEY, Atherton, CA (US); Parth S. CHANDRA, Palo alto, CA (US); Dinker CHARAK, Bangalore (IN); Sanjay DAHIYA, Bangalore (IN); Sandeep KUMAR, Bengaluru (IN); Hans GUNTREN, Truckee, CA (US)

(21) Appl. No.: 13/297,064

(22) Filed: Nov. 15, 2011

Related U.S. Application Data
(60) Provisional application No. 61/417,813, filed on Nov. 29, 2010.

(51) Int. Cl. G06Q 30/02

(52) U.S. Cl. 705/14.43; 705/14.45

(57) ABSTRACT

Techniques are provided by which brand awareness metrics are defined and computed. Such brand awareness metrics may include: Awareness, Consideration, Engagement, and Purchase Intent. Such metrics may correspond to stages of a consumer's online buying behavior and may be computed based, in part, on recordings of interactions the consumer has had with an online advertisement.

### CROSS REFERENCE TO RELATED APPLICATIONS

This patent application claims the benefit of U.S. Provisional Patent Application Ser. No. 61/417,813, Intent Analysis Engine, filed Nov. 29, 2010, the entirety of which is incorporated herein by this reference thereto.

### BACKGROUND OF THE INVENTION

1. Technical Field

This invention relates generally to the field of delivery mechanisms for online advertising. More specifically, this invention relates to incorporating an intent analysis engine in an advertising system to enable advertisers to employ the intent analysis engine in corresponding strategies for online advertising.

2. Description of the Related Art

The field of advertising is changing drastically as a result of advancements in technology, such as the popularity of mobile devices, and the decline of print media. Electronic advertisements (“ads”) now appear in websites, video clips, emails, and many other locations, as well as in different media and formats.

One challenge is how improve or increase the viewer's engagement in an advertising campaign. Electronic ads, such as web page banner ads and videos, compete for the viewer's attention, but it may be difficult to attract the viewer's attention to a particular ad. It may be even more difficult to develop and cause sufficient interest that the viewer “clicks” on a banner ad or permits an automatically activated video to run without the viewer closing it.

A separate challenge that may confront advertisers is, once a given strategy is implemented to engage viewers, how to determine the success of the related advertising campaign. Some delivery mechanisms for video advertising collect statistics and report them back to advertisers. In some cases, these statistics include the number of different viewers that started to view a particular video ad and how long the ad ran in viewers' browsers before being closed. However, these statistics are not as comprehensive as some might like to more accurately assess the success of an advertising campaign.

Hence, it may be particularly difficult to gauge the success of techniques implemented to engage viewers when the mechanisms for measuring success of an advertising campaign are limited.

Further, even when mechanisms collect data from an advertising campaign, the use of such data by advertisers may still remain limited. Thus, it would be advantageous for advertisers, who invest resources into collecting raw data, to put such collected data to better use, thereby getting closer to maximizing their market share.

### SUMMARY OF THE INVENTION

1. Techniques are provided by which brand awareness metrics are defined and computed. Such brand awareness metrics may include: Awareness, Consideration, Engagement, and Purchase Intent. Such metrics may correspond to stages of a consumer's online buying behavior and may be computed based, in part, on recordings of interactions the consumer has had with an online advertisement.

### BRIEF DESCRIPTION OF THE DRAWINGS

FIG. 1 is a schematic diagram of an infrastructure for recording user interactions, according to an embodiment;

FIG. 2 is a schematic diagram of an aggregation infrastructure, the diagram showing interactions between components therein, according to an embodiment;

FIG. 3 is a schematic diagram showing an example top screen and an example bottom screen for creating a customer interactivity module, according to an embodiment;

FIG. 4 is a sample screen shot showing a funnel 402 of the four levels, according to an embodiment;

FIG. 5 is a sample screen shot showing a breakdown of the Awareness level for a particular campaign, according to an embodiment;

FIG. 6 is a sample screen shot showing a breakdown of the Consideration level for a particular campaign, according to an embodiment;

FIG. 7 is a sample screen shot showing a breakdown of the Engagement level for a particular campaign, according to an embodiment;

FIG. 8 is a sample screen shot showing a different view of the breakdown of the Engagement level for a particular campaign, including showing a particular Engagement Trend, according to an embodiment;

FIG. 9 is a sample screen shot showing a breakdown of the Purchase Intent level for a particular campaign, according to an embodiment;

FIG. 10 is a sample screen shot showing a different view of the breakdown of the Purchase Intent level for a particular campaign, including showing a particular Purchase Intent Trend, according to an embodiment;

FIG. 11 is a sample screen shot showing the total number and the percentage of interactions per 978 impressions on particular mobile browsers, according to an embodiment;

FIG. 12 is a sample screen shot showing the total number and the percentage of interactions per 978 impressions for particular mobile categories, such as Mobile Applications and WAP/Mobile Web, according to an embodiment;

FIG. 13 is a sample screen shot showing the total number and the percentage of interactions per 978 impressions for particular mobile manufacturers, according to an embodiment;

FIG. 14 is a sample screen shot showing the total number and the percentage of interactions per 978 impressions for particular mobile operating systems, according to an embodiment; and

FIG. 15 is a block schematic diagram of a system in the exemplary form of a computer system according to an embodiment.

### DETAILED DESCRIPTION OF THE INVENTION

Techniques are provided by which brand awareness metrics are defined and computed. Such brand awareness metrics may include: Awareness, Consideration, Engagement, and Purchase Intent. Such metrics may correspond to stages of a consumer's online buying behavior and may be computed based, in part, on recordings of interactions the consumer has had with an online advertisement.

### Measuring Online Consumer Behavior

### High Level

In accordance with an embodiment, as a consumer views an advertisement, the consumer may go through multiple stages of a decision making process that may culminate in a buying decision. Various stages of the decision making process may be as follows:
Awareness—The viewer has been made aware of the existence of the product or service.
Consideration—The viewer is now thinking that what he or she is viewing might be a product or service in which he may be interested in purchasing.
Engagement—The viewer is actively trying out the various aspects of the product or service to evaluate such product or service.
Purchase—The viewer has made a decision to purchase the product or service.

It has been found that current online metrics measurements of impressions and clicks do not provide sufficient information to an advertiser or marketer about the consumers buying behavior. For purposes of discussion herein, an impression is a display of an advertisement. For example, an impression may reflect that the consumer is now aware of the product while a click may signify that the consumer is interested. However, the marketer can obtain no insight beyond consumer awareness and interest.

It should be appreciated that impressions may arrive from an in-stream or in-banner delivery. Ads may be served either as in-banner, where the ad plays on a specific spot on a web page, or in-stream, where the ad plays in a video player before some video content plays. In the context of intent analysis, the intent of the user is considered to be independent of the delivery method.

An embodiment described herein provides an interactive advertisement in which various interactivity choices made by the user may reflect different stages of the consumer's buying behavior. Such choices made by the user may overcome the above-described limitations and provide an accurate measurement of the consumer's buying behavior. This information may be invaluable to a brand advertiser. The metrics, Awareness, Consideration, Engagement, and Purchase correspond to the stages of the consumer's buying behavior and are computed based, in part, on recordings of the interactions the viewer has had with an advertisement.

In an embodiment, techniques concerned with incorporating the brand awareness metrics of Awareness, Consideration, Engagement, and Purchase Intent, may be incorporated into existing advertising platforms, such as that described in co-assigned and co-pending patent application Ser. No. 12/939,064, filed Nov. 3, 2010, and entitled, “METHOD AND APPARATUS TO DELIVER VIDEO ADVERTISEMENTS WITH ENHANCED USER INTERACTIVITY.” The entirety of the foregoing application is hereby incorporated herein by this reference thereto.

### An Exemplary Intent Analysis Process

An embodiment provides a process that starts with a user being aware of the brand. This is the ‘Awareness’ stage. Having maximum awareness may be the first and important stage in the process.

An aware user then considers the brand for their consumption. This is the ‘Consideration’ stage. Allowing a user multiple avenues to consider the brand may be important, as such consideration may also convey the attitude or reaction of a user to a brand.

Consideration may lead to a user interacting and engaging with the brand. This is the ‘Engagement’ stage. Engagement may come in the form of exploring, sharing, and marking for future reference.

An engaged user may act in way that conveys an intention of purchase. This is the ‘Purchase Intent’ stage. A user takes definitive steps to purchase the product of the brand.

In an embodiment, a report may be provided that allows advertisers to understand and map interactions at the previously mentioned stages into a brand awareness funnel. To allow for comparison of metrics at each stage or level, the percentage used is per video advertisement impressions. Further detail is provided hereinbelow.

### Awareness

Awareness is measured as the sum total of all events a user caused in the course of the display of an advertisement (“ad”). Examples of interactions may include, but are not limited to: views, interactions, audio control, etc. If for a sample campaign, for 1000 impressions an embodiment delivered 900 views and 50 interactions, the awareness percentage is 95%. There may be cases when the views exceed the impressions, e.g. user replays the ad a sufficient number of times, or the number of interactions is high, e.g. sufficient to make up for difference between views and impressions. In such cases, awareness percentage may be more than 100% reflecting the value-add provided.

### Consideration

Of the users who became aware of the brand, only a fraction may consider the brand. Consideration is measured as the sum total of all events that convey the user considered the brand in the course of the display of an ad. An example of an event that conveys the user considered the brand is a viewer opening an interaction panel or companion banner of a product. If for a sample campaign, for 1000 impressions the embodiment delivered 900 views and 50 interactions, the consideration percentage is 5%.

### Engagement

Of the users who have considered the brand, only a fraction may choose to engage. Engagement may be measured as the sum total of all the interactions that allow a user to share, engage with the brand, contact advertisers, and interact with brand specific customized interactions. The engagement percentage is computed on an impressions basis. For example, if the user opens a video that shows more information about the product, then the user is definitely engaged. A concrete example would be a user watching a second video about, for instance, the ‘making of the music video, in an ad for a music album. If 50 users viewed the second video out of a thousand impressions, the engagement percentage would be 5%.

### Purchase Intent

Of the users who have engaged with the brand, only a fraction may choose or show purchase intent. Such interactions may ask the user to contact the advertiser, complete forms that send purchase intent information to the advertiser, or interact with customized interaction that have been marked as such by the advertiser. Purchase intent is measured as the sum total of such interactions. The purchase intent percentage is computed on an impressions basis.

### An Example Implementation of Intent Analysis

An embodiment may be understood by the following example. In the example, an advertisement may have the following components with which a user may interact:
An Interact now bar—click on the Interact now bar to open an interaction panel or open a companion banner ad.
Sharing options—share the advertisement with a friend, forward to a friend, post on a social networking site, e.g. Facebook, Palo Alto, Calif. or Twitter, San Francisco, Calif., and so forth.
Custom options—watch a promotional video, download an informational brochure, invoke a dealer/store locater, click on a purchase online link, etc.
Standard interactions—download a promotional coupon.

It should be appreciated that the list of examples is not intended to be exhaustive.

An embodiment may obtain a measurement of the various brand awareness metrics by taking a count or average of these interactions. For example, every time an advertisement plays to completion, which may be counted as an advertisement view, an embodiment counts such view as an indicator that a viewer has been made aware of the product. As such, advertisement views may be counted as part of the awareness metric. Opening the interaction panel or companion banner may imply the user may be considering the product. That is, the user has moved to the next stage beyond becoming aware of the product. Sharing on a social networking site or downloading an informational brochure indicates the viewer is engaged with the product. Thus, such sharing or downloading may be counted in the engagement metric. Clicking on the online purchase link or coupon download link may be counted as part of the purchase intent metric.

### Analytics Infrastructure

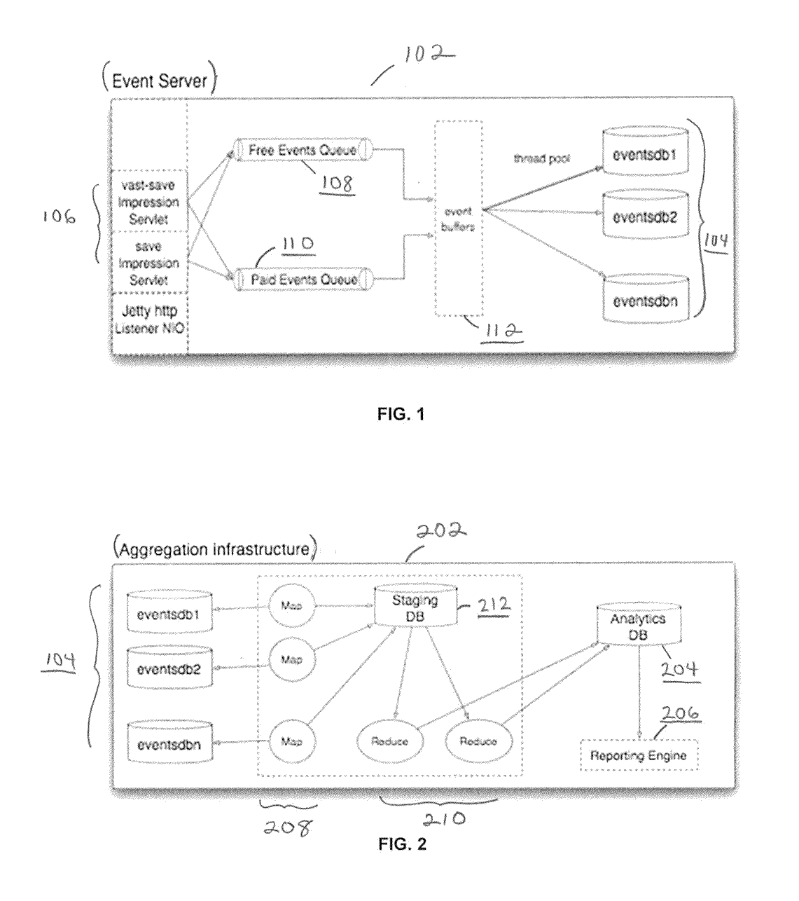

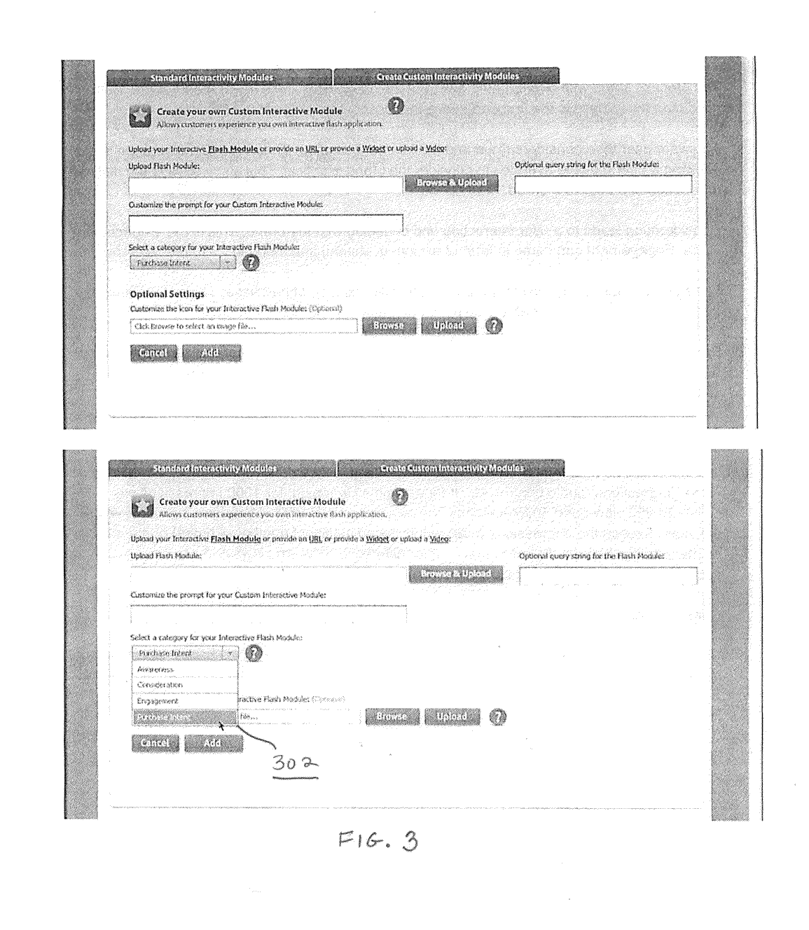

An embodiment of an analytics infrastructure may be understood with reference to FIG. 1 and FIG. 2. FIG. 1 is a schematic diagram of an infrastructure for recording user interactions, according to an embodiment. FIG. 2 is a schematic diagram of an aggregation infrastructure 202, the diagram showing interactions between components therein, according to an embodiment. The embodiment includes:
Advertisement players that record viewer interactions with the advertisement as it plays. One exemplary advertisement player can be found in co-pending and commonly assigned U.S. patent application Ser. No. 12/939,064, filed Nov. 3, 2010, which is incorporated in its entirety by this reference thereto. For example, one skilled in the art may refer to FIGS. 1, 5, 6 and the accompanying text in such commonly assigned patent application. For instance, in FIG. 1, reporting server refers to a combination of the event recording server and the analytics engine referred to herein. As well, in FIG. 6 of the commonly assigned patent application, the Station refers to the server processes;
Event recording infrastructure that consists of multiple servers, one of which is an event server 102 that records the events to multiple instances of event recording databases 104. Or, put another way, data is saved on disk in multiple databases 104. It should be appreciated that event server 102 receives user activity events 106. Event server 102 comprises a free events queue 108. Free events queue 108 comprises, but is not limited to, events such as interaction panel open or mute/unmute that does not incur a charge for the advertiser. Event server 102 comprises a paid events queue 110. Paid events queue 110 comprises, but is not limited to, events such as ad impression, video completion, or user click on interactivity for which the advertiser may be charged. Event server 102 comprises one or more event buffers 112. Data is kept in such buffers, i.e. in memory, before being written to disk;
A parallel data aggregation infrastructure 202 that comprises corresponding processes, as follows. The aggregation infrastructure uses data that is recorded by the event servers in multiple databases 104. Mapping processes take data from multiple databases 104, perform aggregation processes and other analytical processes on such data and write, but is not limited to writing, resulting data to a staging database 212. It should be appreciated that for every database, data is aggregated and processed by many parallel processes that write to staging database 212. From staging database 212, another set of parallel processes write to a final analytics database 204. Such processes may be referred to as reduce processes 210. In the embodiment, the processing is done by such reduce processes 210 in parallel. Particular processing of reduce processes may include, but are not limited to, simple adding the total impressions for an ad campaign and may include complex processing such as determining the user engagement analytics for a campaign. Thus, aggregation infrastructure 202 is configured to aggregate raw data into an analytics database 204; and
A report building platform 206 that may query analytics database 204 and display the data in various forms.

For example, in an embodiment, an interactivity that is available to a viewer may be tagged by an advertiser as belonging to a particular category. The phrase, by category, means whether the particular interactivity should be categorized as Awareness, Consideration, Engagement, or Purchase Intent. Once a viewer interacts with an interactive component, the interaction is counted towards the corresponding or relevant category, i.e. Awareness, Consideration, etc. For example, the viewer may start watching an ad for financial services. Then the user may click a secondary video that shows information about retirement planning. It should be appreciated that this secondary video may be categorized as Consideration by the advertiser. Thus, the analytics system immediately counts that interaction as a ‘Consideration’ event. However as the duration of the interaction increases, e.g. the video may be 10 minutes long and the user watches the video all the way to the end, it may be concluded that the user is no longer in the Consideration stage but in the Engagement stage. The analytics system will then change the original (base level) categorization and recategorize the interaction as an Engagement event. The same method is applied when the number of interactions with the same interactive component increases. In the example, when the user rewinds and views a particular portion of the video multiple times, the embodiment may again recategorize the interaction as an Engagement interaction. In another embodiment, different computations may be performed and displayed as a user selects different parts of a purchase funnel, i.e. different levels from awareness of a product or service to demonstrating intent to purchase the product or service. Interactivity data is collected by event server 102 and categorized periodically by the aggregation processes. The data in the reports 206 is picked up from the analytics database 204.

### Recording the Viewer's Activity

In accordance with an embodiment, the richness of the user activity recorded may determine the accuracy of the metrics a system may compute. Thus, in an embodiment, the advertisement player may record the following, but is not limited to, predefined events that may be pre-categorized in the metadata. These predefined interaction events are defined in a database table where they are given or assigned an event identifier, a name, what action the ad player takes when the event occurs, e.g. takes the user to a new web page, starts a video, or sends an email, etc. The definition of these events is precategorized, i.e. the embodiment also specifies whether the event is an Awareness, Consideration, Engagement, or Purchase intent event.
Advertisement (“Ad”) View
Click Through
Promo Click
Email Info Open
Email Info Submit
Share via SMS Open
Share via SMS Submit
Email Friend Open
Email Friend Submit
Embed URL
Companion Banner Expansion
Interactivity Panel Open
Share This
View Thru
Share on Facebook
Share via Twitter
Share on Myspace
Share on Google Buzz
Mute
Unmute
Facebook Like
Facebook Become a Fan

In addition, an advertiser may specify custom interactivity options to be played in an advertisement. Custom interactivity may consist of URL's or code, e.g. Flash by Adobe Systems Incorporated or JavaScript, that executes when a user clicks on the button or image representing that interactivity. For example, an advertisement for a sports car may feature an interactive piece of code that allows the viewer to select a car model and customize the trim of the car. User activity on such custom interactivities may be recorded as custom events. For example, a custom event may be that a user configured the trim on a sports car, such as in the prior example, or another custom event may be the user tried to locate a nearby car dealer. An embodiment may record the opening and closing of these custom interactivities. An embodiment may also be extended to provide a callback or server API that the custom interactivity code may call to record custom events from custom interactivity.

### The Metrics

### Identifying Events at Each Level

An embodiment can be understood by reference to Table 1. Table 1 shows elements unique to a level. That is, Table 1 shows the four fundamental levels and the events in each that may be counted. Each level may imply the user has passed through the previous level. For example, the user who has shown the purchase intent was also aware of the advertisement, considered it, and was engaged with it.

TABLE 1
Awareness
Views
Consideration
Companion Banner Expansion + Interactivity Panel Open + Mute + Unmute
Engagement
Click Through + Email Info Open + Share via SMS Open +
Share via SMS Submit + Email Friend Open + Email Friend Submit +
Embed URL + Share This + Share on Facebook +
Share via Twitter + Share on Myspace + Share on Google Buzz +
Facebook Like + Facebook Become a Fan + All Custom Interactions
Purchase Intent
Promo Click + Email Info Submit + View Thru + Custom Interactions

### Awareness

The awareness level may imply the user has become aware of the brand. In accordance with an embodiment, a rule of thumb for identifying events at the awareness level may be, but are not limited to, events that happen without user action, e.g. a video ad starts playing automatically when the ad is served. There is the possibility that Awareness is more than 100%. This is acceptable because this means that, for example, more items, e.g. views+interactions, were delivered compared to impressions.

In an embodiment, the awareness total may be the sum of particular detected events. For example, Awareness Total=View+Click Through+Promo Click+Email Info Open+Email Info Submit+Share via SMS Open+Share via SMS Submit+Email Friend Open+Email Friend Submit+Embed URL+Companion Banner Expansion+Interactivity Panel Open+Share This+View Thru+Share on Facebook+Share via Twitter+Share on Myspace+Share on Google Buzz+Mute+Unmute+Facebook Like+Facebook Become a Fan+All Custom Interactions

Awareness Percentage=Awareness Total/Impressions*100

### Consideration

In accordance with an embodiment, a rule of thumb for identifying events at the consideration level may be: Events that happen on an advertisement player and events that provide the user with opportunity to engage, e.g. in default or most common configurations.

In an embodiment, the consideration total may be the sum of particular detected events. For example, Consideration Total=Click Through+Promo Click+Email Info Open+Email Info Submit+Share via SMS Open+Share via SMS Submit+Email Friend Open+Email Friend Submit+Embed URL+Companion Banner Expansion+Interactivity Panel Open+Share This+View Thru+Share on Facebook+Share via Twitter+Share on Myspace+Share on Google Buzz+Mute+Unmute+Facebook Like+Facebook Become a Fan+All Custom Interactions

Consideration Percentage=Consideration Total/Impressions*100

### Engagement

In an embodiment, the engagement total may be the sum of particular detected events. For example, Engagement Total=Click Through+Promo Click+Email Info Submit+Share via SMS Submit+Email Friend Submit+Embed URL+Share This+View Thru+Share on Facebook+Share via Twitter+Share on Myspace+Share on Google Buzz+Facebook Like+Facebook Become a Fan+All Custom Interactions

Engagement Percentage=Engagement Total/Impressions*100

### Purchase Intent

In an embodiment, the purchase intent level may be defined based on the following observation: Of the users who have engaged with the brand, only a fraction chooses show purchase intent.

In an embodiment, the purchase intent total may be the sum of particular detected events. For example, Purchase Intent Total=Promo Click+Email Info Submit+View Thru+All It should be appreciated that in an embodiment, custom interactions may be achieved by interaction with widgets, e.g. in SWF file format that are forms or widgets explicitly marked as ‘Purchase Intent’.

Purchase Intent Percentage=Purchase Intent Total/Impressions*100

### Items for Breakdown Graph

An embodiment may be understood also with reference to Table 1. It should be appreciated that when a configuration has received many interactions in a campaign, the embodiment shows the top interactions, e.g. the top four (or more when space permits) interactions and groups the remaining into another group, e.g. ‘Others.’ An embodiment may not show interactions that have zero count.

### Trends

In an embodiment, each trend may be shown as an individual level trend. For example, Awareness trends may be shown in one graph rather than trends for the three levels, Consideration, Engagement, and Purchase Intent, shown in one graph. A trend chart shows the Awareness, Consideration, Engagement or Purchase Intent for a campaign as it varies on a daily basis, for the duration of the ad campaign.

### UI

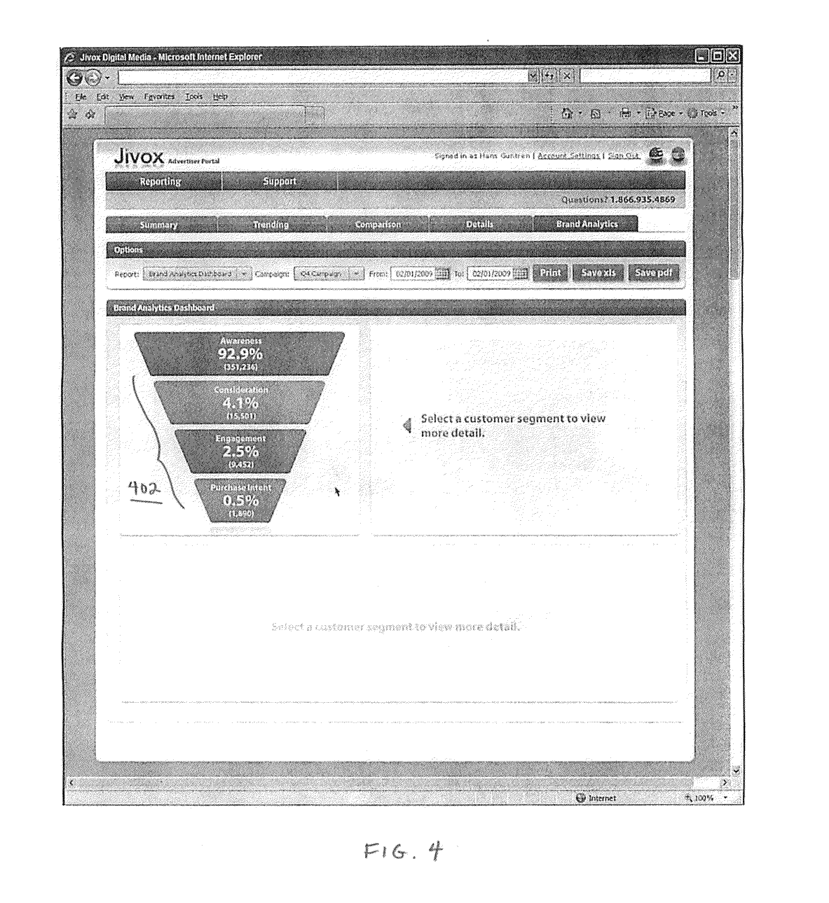

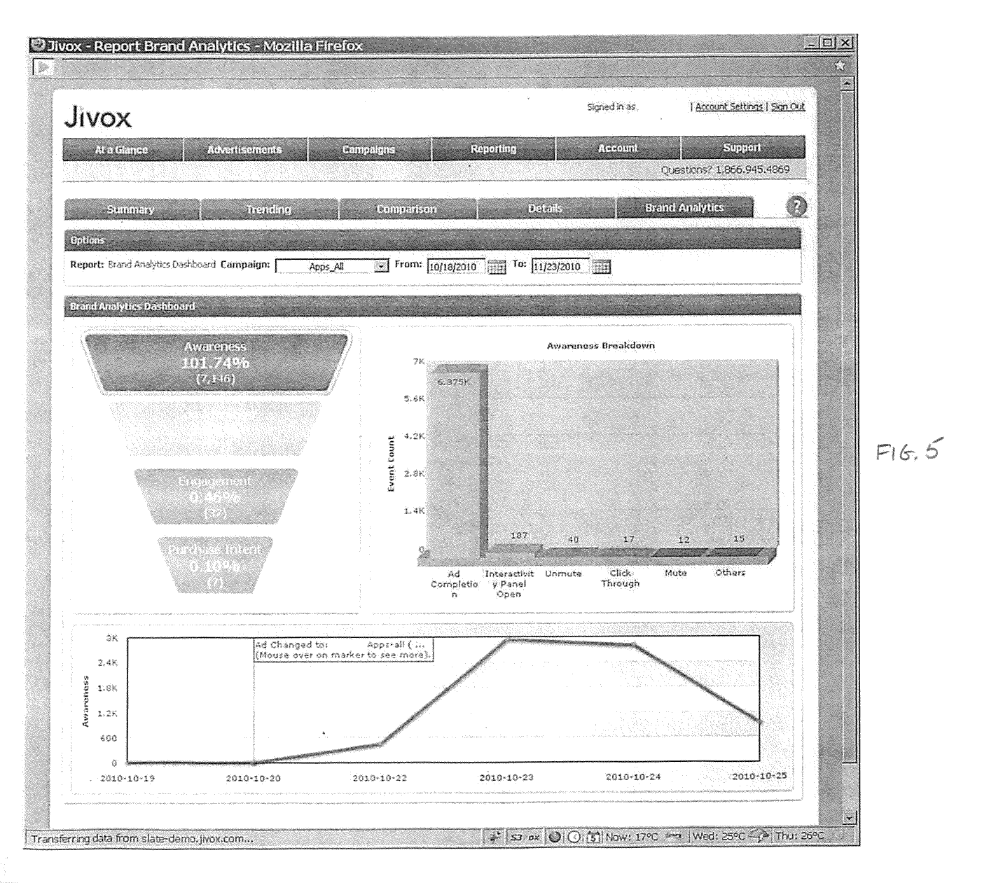

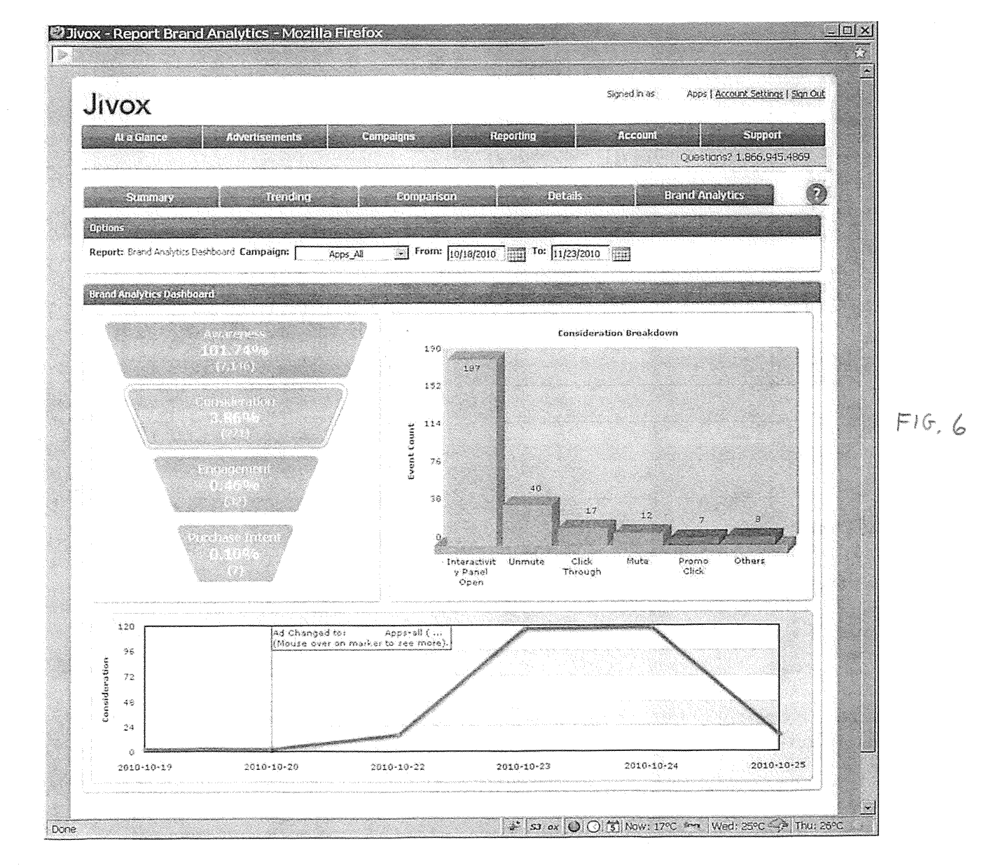

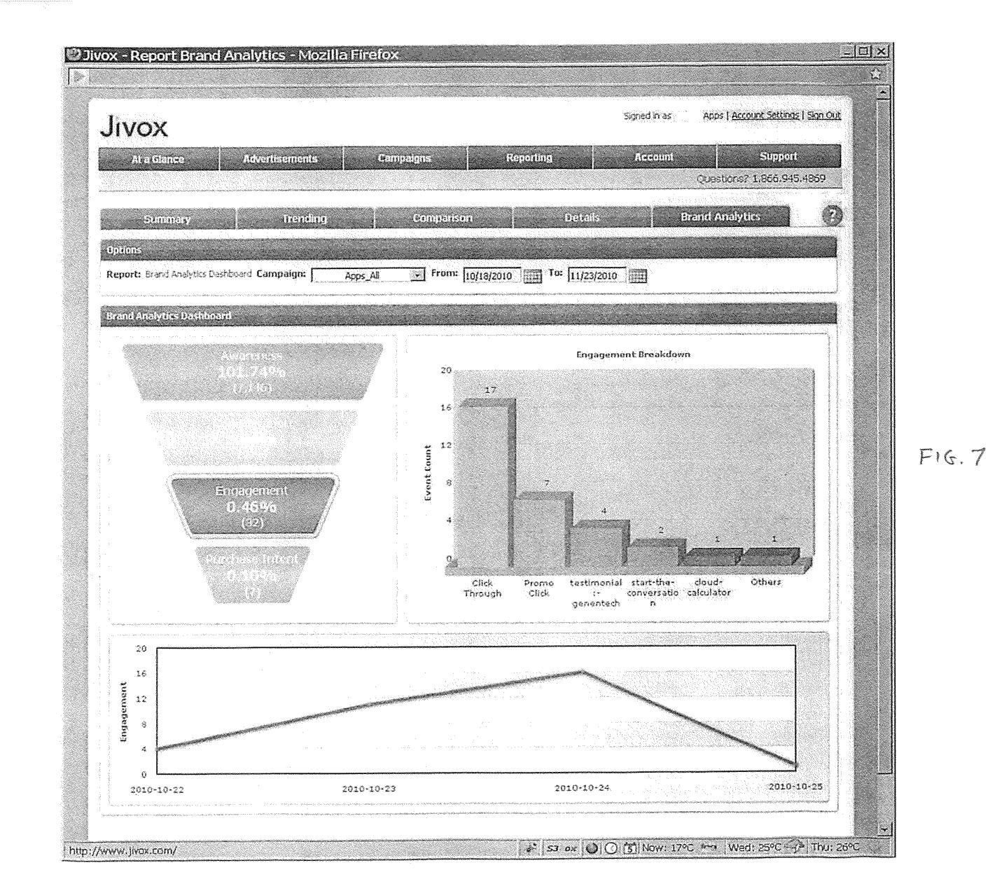

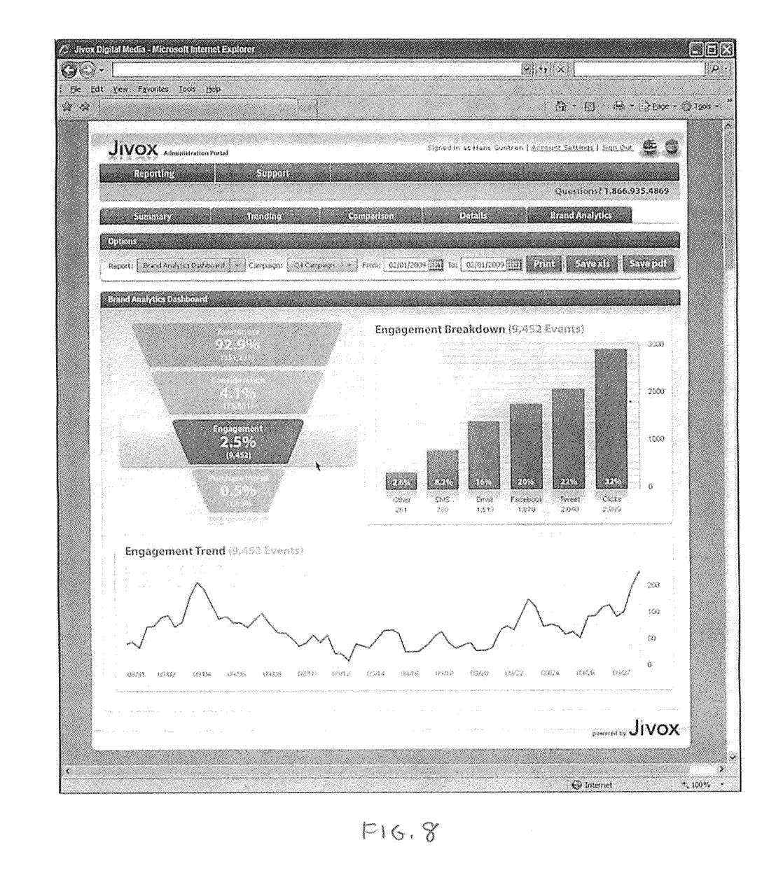

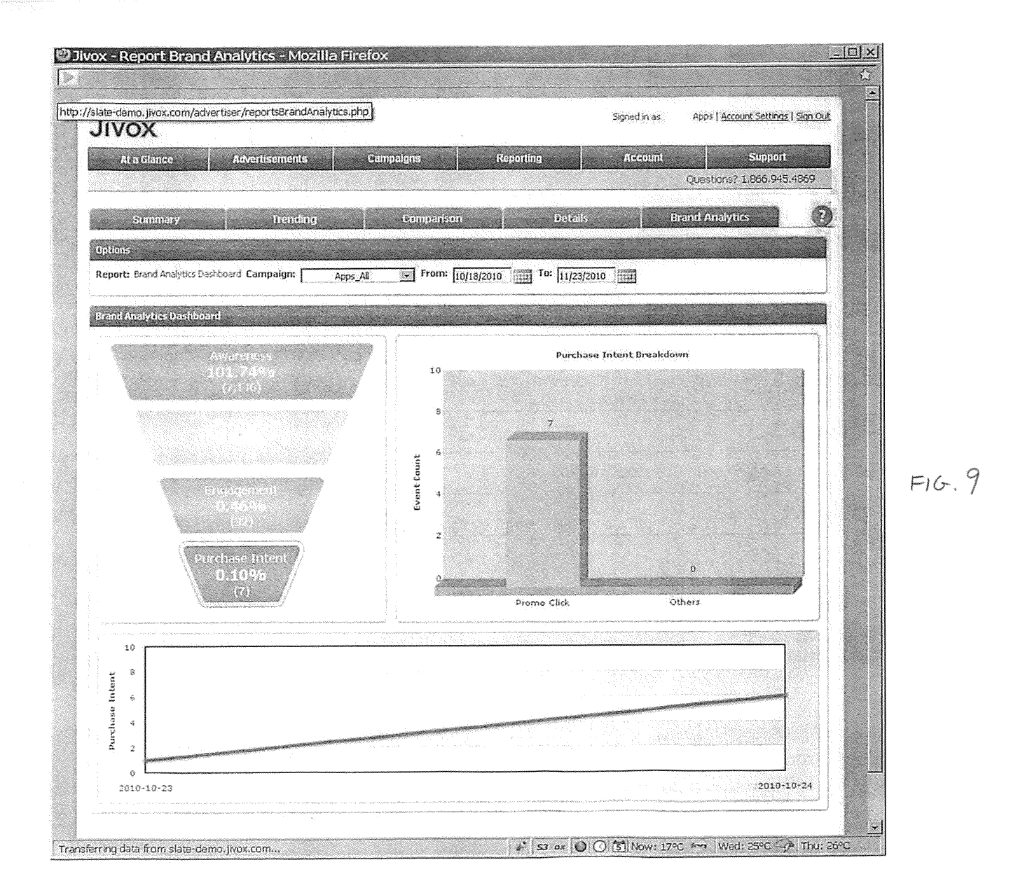

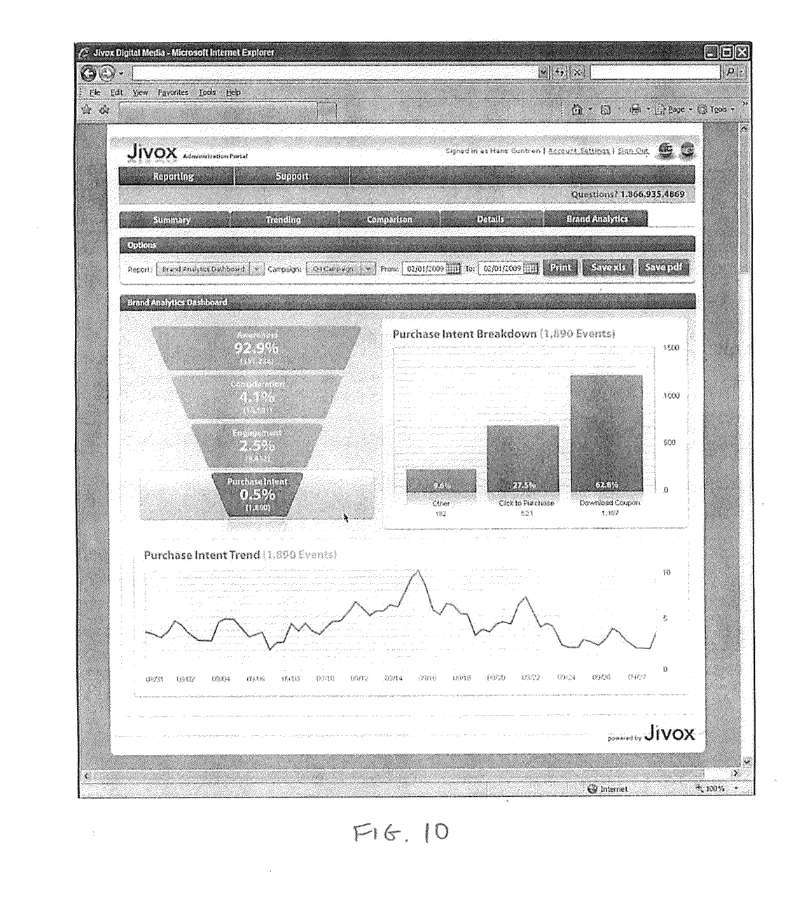

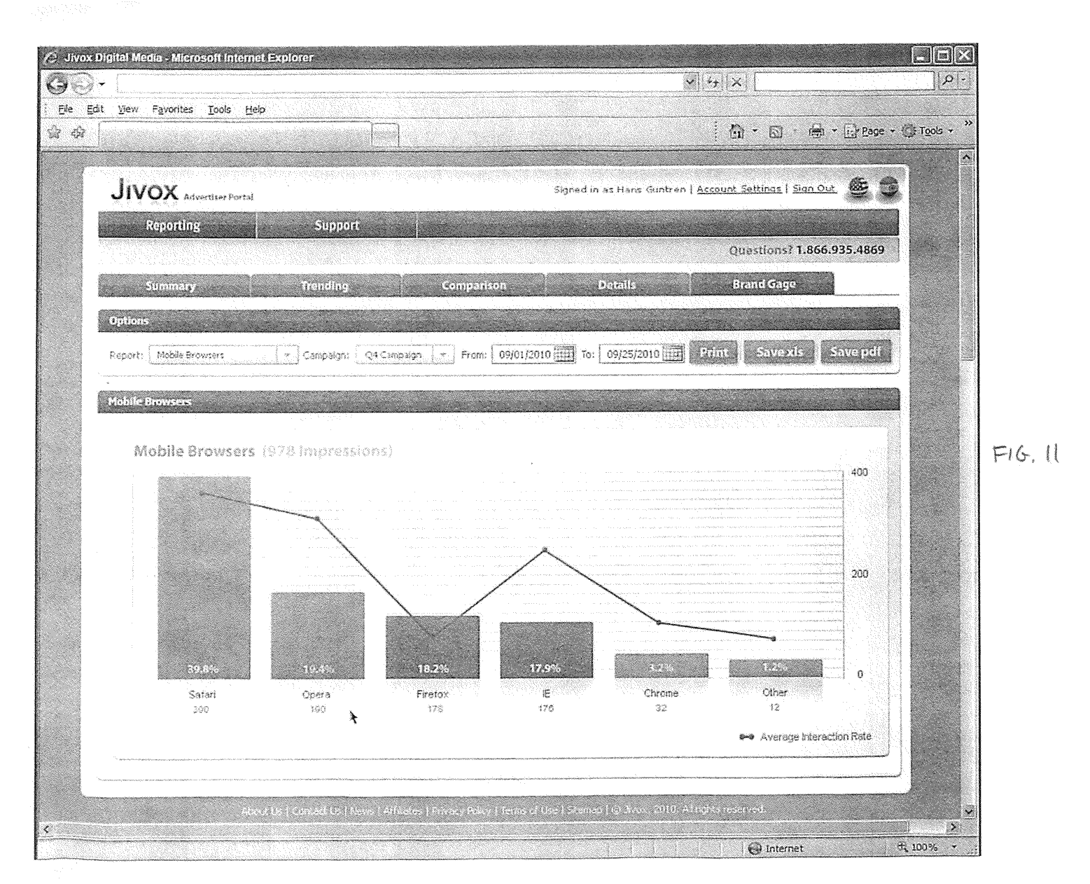

FIG. 3 through FIG. 10 show example user interfaces used for creating customer interactivity modules to breakdowns for each level. FIG. 3 is a schematic diagram showing an example top screen and an example bottom screen for creating a customer interactivity module. The bottom screen shows that the user is selecting the level to be Purchase Intent 302. FIG. 4 is a sample screen shot showing a funnel 402 of the four levels. The viewer is asked to select a customer segment to view more detail. FIG. 5 is a sample screen shot showing a breakdown of the Awareness level for a particular campaign. The viewer may see the total number of events for particular activities, such as “Click-Through” and “Mute.” As well, the view can see the total number of events over time. For example, the total number of events for 2010-10-22 and 201-10-23 are shown. FIG. 6 is a sample screen shot similar to FIG. 5, however shows a breakdown of the Consideration level for a particular campaign. FIG. 7 also is a sample screen shot similar to FIG. 5, however shows a breakdown of the Engagement level for a particular campaign. FIG. 8 is a sample screen shot showing a different view of the breakdown of the Engagement level for a particular campaign, including showing a particular Engagement Trend. FIG. 9 is a sample screen shot similar to FIG. 5, however shows a breakdown of the Purchase Intent level for a particular campaign. FIG. 10 is a sample screen shot showing a different view of the breakdown of the Purchase Intent level for a particular campaign, including showing a particular Purchase Intent Trend.

### Categorizing Custom Interactivity

In an embodiment, it may not be possible to predefine the category that the interactivity option falls under when the interactivity is a custom interactivity. Thus, the UI provides a way by which the custom interactivity option may be categorized by a user, e.g. the advertiser, when the interactivity is added to the advertisement.

The entered information about categorizing the custom interactivity may then be used by the aggregators the same way as the predefined categories are used for the standard interactivities. For example, in an ad for financial services, the custom interaction to view a video on retirement services may be categorized as a Consideration interaction while a custom interaction to fill out a form asking for more information may be categorized as a Purchase Intent interaction.

As well, the same methodology may be employed by a user to change the predefined category for a standard interactivity option. Thus, an embodiment provides the user, e.g. the advertiser, a way of overriding the classification. For instance, in the example above, the advertiser may have included a standard interactivity which takes the viewer to the advertiser's website. This interaction is categorized as a Consideration interaction; however, the advertiser may choose to change that categorization and consider it an Engagement interaction.

### Adjusting the Metrics for Time Spent

In an embodiment, metrics computed as percentages, e.g. watching a secondary video, may need to be adjusted to take into account the time spent by the viewer on a single interactivity option, such as follows. Most interactivity options are single interactivity options, such as single click operations, e.g. companion banner expansion and mute/unmute. Other interactions are short lived, such as operations including email to a friend and forward via SMS. Such interactions are interactions that may require some small amount of data to be entered by the user. In these types of cases, the time spent by a user on the interactivity is a function of the amount of time it takes for the user to enter the data. However, opening the interaction panel that may have embedded custom interactions, such as secondary videos in the advertisement, may involve longer durations of user engagement. Such longer interaction may result in moving the viewer further towards a purchase decision. Put another way, the longer a user has spent in an advertisement, the more likely he or she is to buy the product. Thus, an embodiment adjusts the definition of the metrics to dynamically determine what level an interaction falls into, based, in part, on the time spent.

To incorporate the effect of the viewer spending more time on the interactivity, an embodiment counts an interaction in its base level at the start of the interaction, but as the viewer spends more time on that interaction, the embodiment promotes that particular occurrence to the next, e.g. higher, level, and then to the next level and so on.

To perform the above steps, an embodiment establishes or uses predetermined thresholds of time after which a viewer is required to be moved to the next level in the purchase decision. In addition, an embodiment defines the base level or uses a predefined base level, as well as a limit for every interaction type. For purposes of discussion herein, the limit defines the maximum level at which a particular interaction may be promoted.

In accordance with an embodiment, such thresholds may be determined in different ways. Following are some examples:

a) After fixed time intervals. Given that it has been found that the average length of an internet advertisement is 15-30 seconds, an embodiment chooses a threshold time limit of 30 seconds on an interaction to move the interaction to the next level. This kind of approach may be used for custom interactivities that have no fixed duration, e.g. a game that can be played as long as one wants.
b) As a percentage of the total duration of the interactivity. For example, suppose the interactivity is a secondary video that may be several minutes long. An embodiment may choose a percentage threshold of the duration of the secondary video to move the interaction to the next level. For example, the embodiment may choose 30%, 60%, or 90% thresholds of the duration of the secondary video to move the interaction to the next level.
c) Determine the threshold values by dynamically comparing with the median or quartile values of the time spent on the particular interaction. For example, a secondary video is watched for 5 seconds by 75% viewers, 8 seconds by 50% viewers, and 10 seconds by 75% of the viewers. By dynamically computing the quartiles of all previous interactions, an embodiment may establish the thresholds at which the interaction is moved to the next level. The quartile computation may be done periodically and applied retroactively to previous interactions. Such technique may be applied to longer duration interactivities. For purposes of discussion herein, longer duration interactivities are defined as interactions that last longer than the duration of the primary video ad. For example, a primary video ad is typically 15-30 seconds, thus any interaction lasting longer than 30 seconds may be a longer duration interactivity. Further examples include, but are not limited to, watching a secondary video or playing an interactive game.

It should be appreciated that such examples are not meant to be exhaustive.

### Adjusting for the Number of Interactions in a Session and Repeat Sessions

An embodiment adjusts metrics for the number of interactions in a session and repeat sessions. Such methodology is similar to the adjustment for time spent except that the threshold is determined based on the number of interactions. In this case, an embodiment keeps track of the total number of interactions a single viewer registers in a single session or, alternatively, across more than one session. As the total number of interactions crosses a given threshold, subsequent interactions may be promoted to the next level. For example, if a user has viewed a secondary video more than twice (the threshold having been defined as watching the video two times), the first two interactions may be counted as Consideration while the third and subsequent interactions may be counted at the next level, Engagement. When a viewer is exposed to the same advertisement campaign many times, an embodiment keeps track of the total number of interactions recorded previously and starts counting therefrom.

Total interactions=Total interactions for all previous sessions+interactions in current session. Again as the number crosses a threshold, the level of interactions is promoted to the next level. It should be appreciated that the threshold may be determined by any of the previous methods.

### Tracking Social Interaction Analytics

An embodiment provides another form of analytics that allows brand marketing to be enhanced by the tracking of advertising once the advertisement is spread via social media. For purposes of discussion herein, examples of such social media may be Facebook by Facebook, Twitter by Twitter, Linkedln by Linkedln Corporation, etc. It should be appreciated that such list is not meant to be exhaustive, but is meant to be illustrative.

Typically advertisers will run an advertisement campaign where an advertisement plays on a publisher site for a given period of time. Using social media, an advertiser may post a link to the advertisement and the link is available even after the initial campaign is over. For example, the link for the movie, “Alice in Wonderland,” may still be available on a webpage, such as Facebook, even when the movie is no longer playing in theatres.

Thus, during the course of the campaign, users may click on the ‘sharing’ options of the advertisement, thereby spreading the link to the advertisement onto various social media.

An embodiment herein causes and enables the collection of analytics that allow the advertiser to view and determine how the advertisement performed both during the initial run, i.e. when the advertisement is available on many web sites, and after the campaign is over, i.e. when the advertisement is available through social sharing sites. Examples of such analytics may include, but are not limited to, the number of times an ad was viewed and the number of and type of interactions the viewer had with the ad or any interactive elements in the ad.

An embodiment, e.g. the Jivox system, allows viewers to spread the advertisement virally, e.g. by using the social sharing options embedded in and made available to viewers in the advertisement player.

In addition, an embodiment, e.g. the Jivox system, is configurable to generate a dynamic web page that may host the advertisement both during and after the campaign run. The link to this page is embedded on the various sites on which the viewer chooses to share the advertisement, when the viewer chooses to share the advertisement via social media sites.

In the embodiment, each such link is tagged with the name of the social sharing site.

When a viewer views an advertisement that has been shared using social media, the tagging allows the event recording server to distinguish and determine which social media sites were more effective in spreading the advertisement. For example, when an ad is shared on Facebook, the ad player may be invoked with a tag ‘site=facebook’ and when it is shared on Twitter, headquartered in San Francisco, Calif., the ad may be tagged as ‘site=twitter’. When metrics that describe the effectiveness of an ad are computed, e.g. and in particular the ‘interaction rate’ (the number of interactions as a percentage of the number of ad impressions), it may be found that the interaction rate for the ads when shared on Facebook is much higher than the interaction rate for when ads are shared on Twitter. Such computation allows advertisers to compare the impact of sharing on various social sharing sites.

### Event Server

For purposes of discussion herein, the event recording server, also referred to as event server, is a server process that collects and records messages from the ad player where each message corresponds to a specific event that may have occurred while the ad played in the ad player. Events that are recorded may include, but are not limited to, the starting of an ad, the completion of an ad, the user muting/unmuting an ad, the viewer rewinding and playing the ad again, or the user interacting with interactive components in the ad. For every such event, there is a unique identifier that identifies the event that occurred. When the event occurs, e.g. the viewer unmuted the ad, the ad player constructs a message and sends it to the server and the server records it. Such message contains, but is not limited to, information about the event, e.g. the event identifier, the time the event occurred, what ad was playing and so on. The event server collects the messages from the ads being played and records such messages in the database. It should be appreciated that in a production or development environment, many instances of the event server may be running to handle the load of the ads playing.

Because the advertisement may continue to exist long after the campaign is over, the advertiser may hence study the trailing effect of the advertisement in the analytics recorded after the campaign is completed. For the purposes of discussion herein, the trailing effect is defined as the impact the advertisement continues to have even after the original ad campaign is completed.

An advertiser may choose to leverage a successful campaign if they discover that the advertisement continues to be popular in social media. For example, a car manufacturer may run a very successful ad that users share frequently on social sharing sites. Because the theme of the first ad was so popular, the car manufacturer may use the same theme again for another car model.

### Requirements for Social Media Tracking

In accordance with an embodiment, the system keeps track of the number of times a particular link is posted to social sites and shared. For example, if an advertisement has been posted to a Facebook page and is shared again from such landing page, the system is configured to keep track of the number of shares.

As well, the system may be configured to report the number of impressions and interactions from social media sites before and after the campaign was over. For example, a campaign may be set up to deliver 1000000 impressions over a period of one month. At the end of the month, the ad is no longer being delivered to any web pages, but because it was shared on a social sharing site, viewers are still able to view the ad. Such additional impressions of the ad and the interactions that occur with the ad after the campaign is officially over are the trailing effect due to social network sharing.

For tracking Facebook impressions and interactions an embodiment either embeds the ad player itself in the viewers' Facebook page or embeds a link to the ad in the viewers' page. With each such share, the embodiment keeps a counter as part of the embedded player or link. Thus, when the ad is shared a second time, the ad sharing code updates the counter such that how many times the ad was shared may be determined or computed.

The same technique may be used for Twitter. It should be appreciated that presently the ad cannot be embedded in Twitter. Thus, an embodiment shares the link to the ad.

Note that it is possible for a user to ‘Like’ an ad in Facebook or retweet in Twitter without actually viewing or interacting with the ad. Presently, such informational data can only be obtained from Facebook/Twitter through APIs that provide the total number of shares, likes, and tweets. From this data, an embodiment can compute the ‘secondary’ shares/likes/tweets, i.e. the shares/likes/tweets that occurred from within Facebook/Twitter itself. As an example implementation, the data may be manually extracted from Facebook and Twitter and then compute the secondary shares/likes/tweets.

It should be appreciated that with respect to Twitter and in accordance with an embodiment, retweeting is considered similar to a Facebook share and, thus, each retweet may be counted.

### Device and System Specific Analytics

In an embodiment, the event servers may also record the type of device on which the advertisements were played. Advertisements may play on different operating systems, different browsers, and different video players. With the advent of mobile computing devices, advertisements may also be played on browsers in mobile devices or within applications running on mobile devices.

Such information may be presented in simple tabular form to advertisers. The advertisers may then adapt their targeting to specific devices or systems when desired.

Deeper analytics may be generated from such data. For example, advertisers may learn from such analytics whether a particular advertisement was more successful among tablet computer owners that PC owners.

In an embodiment, interactivity data may be broken down by device type, as follows, for example:
Web
   Browser, Operating system
Mobile
   Browser, Operating System
   Application

### UI

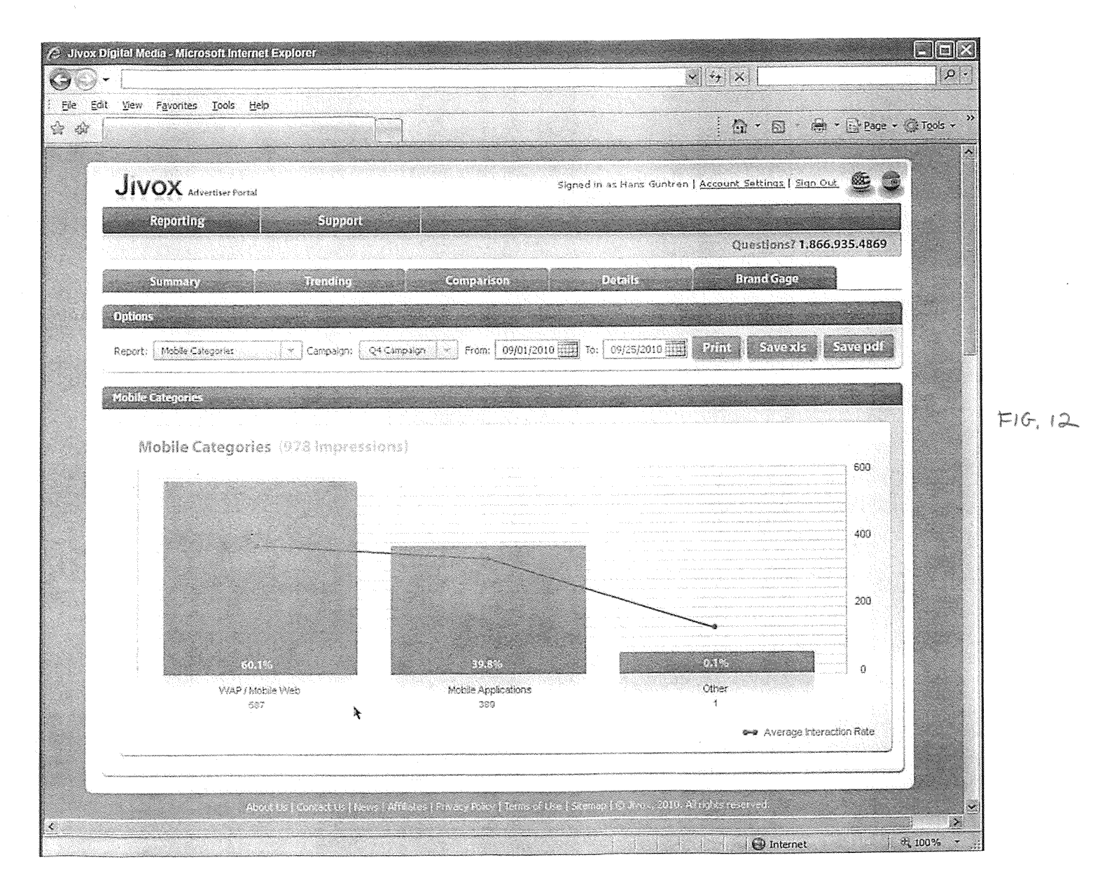

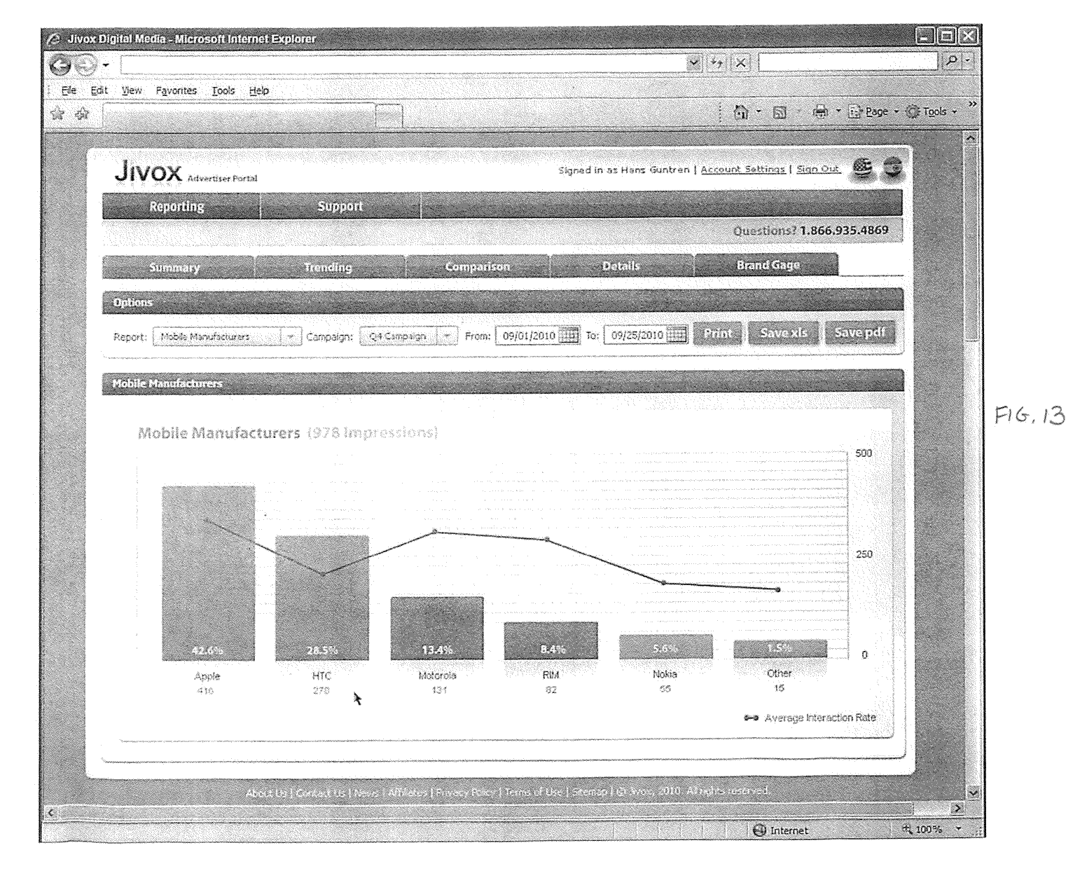

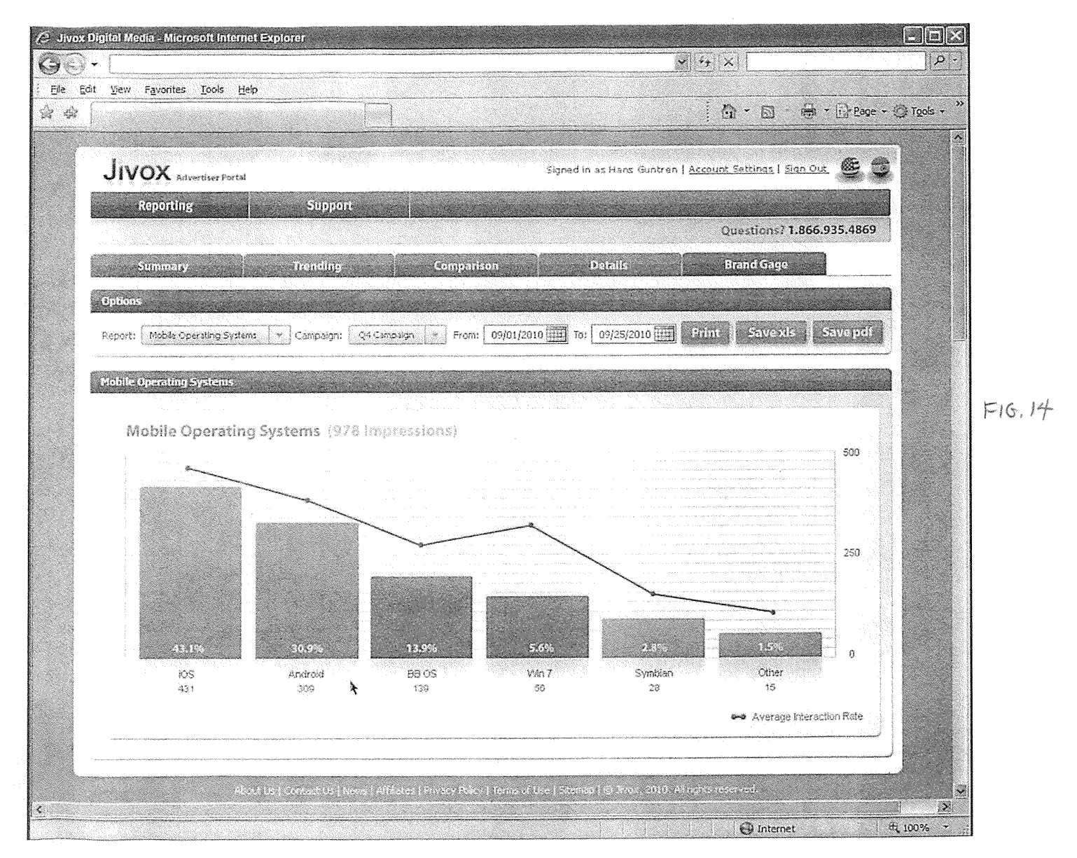

FIG. 11 through FIG. 14 are sample user interfaces for mobile analytics according to an embodiment. Specifically, FIG. 11 is a sample screen shot showing the total number and the percentage of interactions per 978 impressions on particular mobile browsers. FIG. 12 is a sample screen shot showing the total number and the percentage of interactions per 978 impressions for particular mobile categories, such as Mobile Applications and WAP/Mobile Web. FIG. 13 is a sample screen shot showing the total number and the percentage of interactions per 978 impressions for particular mobile manufacturers. FIG. 14 is a sample screen shot showing the total number and the percentage of interactions per 978 impressions for particular mobile operating systems.

### Device/Os/Browser Statistics

Following are lists of devices, operating systems, and browsers about which data may be collected and analytics may be generated. Examples of such analytics may include effectiveness (measured by interaction rate) of the ad on various devices, a list of top devices the ads were referenced from, and a list of top manufacturers. Such lists are by way of example and are not meant to be limiting.

### Device:

iPhone
iPod Touch
iPad

### BlackBerry

### Nokia

### Sony Ericsson

### Motorola

### HTC

### Mac

### PC

### Nexus One

### LG

### Samsung

### Play Station

### Others

### OS:

### Windows 95

### Windows 98

### Windows 2000

### Windows XP

### Windows NT

### Windows ME

### Windows CE

### Windows Vista

### Ubuntu

### Linux

### Mac OS

iOS

### Android

### WebOS

### Windows Phone

### BlackBerryOS

### SymbianOS

### Others

### Browser:

### IE

### Safari

### Firefox

### Opera

curl

### Konqueror

### Chrome

### NetFront

### Others

In an embodiment, the number of times the same user has seen an advertisement is captured, e.g. by using a cookie. For example, by using data from a cookie, an internal report may be generated for a campaign that determines how effective re-targeting has been in improving the brand awareness metrics.

### An Example Machine Overview

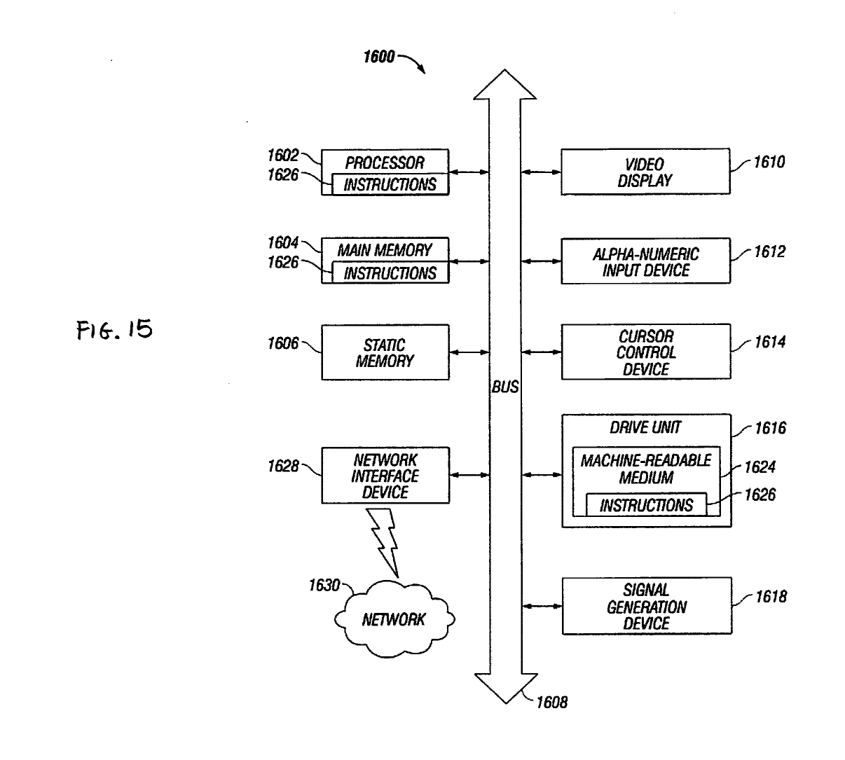

FIG. 15 is a block schematic diagram of a system in the exemplary form of a computer system 1600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method for computing brand awareness metrics, comprising the steps of:
iterating over a plurality of impressions:
for an impression of said plurality of impressions:
detecting one or more events;
for each event of said detected one or more events:
identifying a level from a plurality of levels, said level associated with said event;
responsive to identifying said level associated with said event, adding a count to a total count for said level;
computing said total count for each level over said plurality of impressions to generate an aggregate amount for each level; and
providing said aggregate amount for each level to an end-user or a post-process;
wherein one or more of the steps is performed by a processor.

2. The method of claim 1, wherein said aggregate amount is expressed in percentage of number of said plurality of impressions.

3. The method of claim 1, wherein said plurality of levels comprise: awareness, consideration, engagement, and purchase intent, wherein each of said awareness, consideration, engagement, and purchase intent correspond to a particular stage of buying behavior of a consumer, and wherein each of said awareness, consideration, engagement, and purchase intent is computed based, in part, on recordings of interactions the consumer had with said impression.

4. The method of claim 1, wherein an event is an interaction with an advertisement.

5. The method of claim 1, wherein awareness is measured as a sum of events a viewer caused in the course of said impression, consideration is a sum of events that convey the viewer considered the brand in the course of said impression, engagement is a sum of events that allow a viewer to share, engage with the brand, contact advertisers, and interact with brand specific customized interactions in the course of said impression, and purchase intent is the sum of events that ask viewer to contact the advertiser, complete forms that send purchase intent information to the advertiser, or interact with customized interaction that have been marked as such by the advertiser in the course of said impression.

6. The method of claim 1, wherein said impression comprises one or more custom interactivity options specified by said advertiser and wherein said one or more customer interactivity options provides code that makes a callback or server API call to cause associated customer events to be recorded.

7. The method of claim 1, wherein said impression comprises one or more custom interactivity options specified by said advertiser and wherein said one or more customer interactivity options is categorized by said advertiser into one of said plurality of levels.

8. The method of claim 1, wherein as a viewer spends more time on an event of said one or more events, said event is promoted to a next level based in part on said time spent on said event.

9. The method of claim 1, wherein said total count for each level over said plurality of impressions is equal to total events for previous sessions plus events in current session and when said total count for a particular level crosses a threshold value, said particular level is promoted to a next level.

10. The method of claim 1, wherein said impression is embedded with a link, the activation of which causes the impression to be spread virally onto various social media sites.

11. The method of claim 1, wherein said impression is embedded with a link, the activation of which causes the impression to be spread virally onto various social media, and further comprising reporting impressions and interactions from said social media sites before and after a corresponding advertising campaign is over.

12. The method of claim 1, wherein detecting one or more events further comprises detecting and recording any of: type of device on which the impression is played, operating system used by device, browser used by device, and video player on device.

13. An apparatus for computing brand awareness metrics, comprising:
an iterating processor for iterating over a plurality of impressions;
a detecting processor for detecting one or more events for an impression of said plurality of impressions;
an identifying processor for identifying, for each event of said detected one or more events, a level from a plurality of levels, said level associated with said event;
an adding processor for adding a count to a total count for said level, responsive to said identifying processor identifying said level associated with said event;
a computing processor for computing said total count for each level over said plurality of impressions to generate an aggregate amount for each level; and
a providing processor for providing said aggregate amount for each level to an end-user or a post-process.

14. A non-transitory computer readable medium having stored thereon a computer program comprising a program code for computing brand awareness metrics, the code when executed by a processor, performs the steps of:
iterating over a plurality of impressions:
for an impression of said plurality of impressions:
detecting one or more events;
for each event of said detected one or more events:
identifying a level from a plurality of levels, said level associated with said event;
responsive to identifying said level associated with said event, adding a count to a total count for said level;
computing said total count for each level over said plurality of impressions to generate an aggregate amount for each level; and
providing said aggregate amount for each level to an end-user or a post-process.
